(19) United States
(12) Patent Application Publication
(10) Pub. No.: US 2025/0148788 A1
(43) Pub. Date: May 8, 2025

(54) Deepfake Detection System

(71) Applicant: Bank of America Corporation, Charlotte, NC (US)

(72) Inventors: Dylan Bellinger, Charlotte, NC (US); Sanjay Lohar, Charlotte, NC (US); Kyle Mayers, Charlotte, NC (US); Amado Martinez Suarez, Charlotte, NC (US); Cody Searl, Pineville, NC (US); Rachel Howze, Charlotte, NC (US)

(73) Assignee: Bank of America Corporation, Charlotte, NC (US)

(21) Appl. No.: 18/387,461

(22) Filed: Nov. 7, 2023

(51) Int. Cl. G06V 20/40; G06N 20/00; H04N 21/454

(52) U.S. Cl. CPC G06V 20/46; G06N 20/00; H04N 21/454

(57) ABSTRACT

Various aspects of the disclosure relate to automated monitoring of content associated with an individual for indicators that the content may be a deepfake. A deepfake analysis training device trains artificial intelligence-based models based on validated content associated with one or more profiles. Each profile is associated with an individual. A deepfake analysis engine may be installed on computing devices to monitor access to content (e.g., multimedia content) for deepfakes associated with the one or more profiles, as configured. The deepfake analysis engine may be stand-alone application, an application extension, or may be integrated into third-party applications via application programming interface functions. Analyzed content is assigned a likelihood score that is compared to threshold values that indicates a likelihood that the content is a deepfake. When identified, deepfake content initiates an alert generation and/or blocking of the content otherwise the content is presented to a user.

### BACKGROUND

Presently, malicious individuals and/or organizations my attempt to manipulate audio, video and/or multimedia content for malicious purposes. For example, entities may deepfake individuals for nefarious purposes. These entities may utilize one or more tools that can mimic video content, audio content, and/or textual content of an individual. In the past, the deepfake content may be easily identified through defects introduced when original content was manipulated. As technology improves, such defects may be more difficult for the average human being to identify. As social media content is posted and relied upon as a source of news, deepfake videos may open individuals or organizations to mistaken responsibility. For example, multimedia content may be faked so that an organization and/or person may be associated with improper or malicious content produced by others.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Aspects of the disclosure relate to computer hardware and software. In particular, one or more aspects of the disclosure generally relate to computer hardware and software for monitoring audio, visual, and/or textual content, identifying instances of improperly generated deepfake content and initiating a response based on the identification.

The term, “deepfake” refers to synthetically generated media content that may be digitally manipulated to cause an individual's likeness to convincingly present information not their own. For example, malicious individuals and/or organizations may use artificial intelligence and/or machine leaning algorithms to produce manipulated video content, audio content, textual content, and/or any other digital multimedia format of a person's image and/or voice that appear genuine. As this technology becomes more sophisticated, deepfake technologies are increasingly more difficult for humans to identify. As such, a need has been recognized for applications, browser plug-ins, and the like to automatically identify deepfake content and provide alerts to individuals viewing the content and/or individuals spoofed by such content.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative computing environment to identify deepfake content in accordance with one or more aspects described herein;

FIG. 2 shows an illustrative method for identify deepfake content in accordance with one or more aspects described herein;

FIG. 3 shows an illustrative computing environment in which various aspects of the disclosure may be implemented in accordance with one or more aspects described herein; and

FIG. 4 shows an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

In some cases, an artificial intelligence (AI)-based detection engine may be trained to identify deepfake multimedia content. For example, an AI-based plug-in may be installed on a browser of a user device, where the AI-based deepfake detection plug-in may detect deepfake video content and/or audio content viewed by a user of the device, in real-time. A centralized system may maintain a repository of a plurality of individuals' personas. In some cases, the centralized system may search social media and/or other multimedia content sources to capture verified examples of each individual's voice, facial patterns, gestures, textual tendencies, and the like. The centralized system may provide a trained model associated with configured individuals to a particular system, such as the illustrative browser-plug-in example, that can then analyze new multimedia content against the persona model to determine a likelihood that the multimedia content (e.g., video content, audio content, textual content, and/or the like) is authentic or a deepfake. Additionally, speech patterns may also be monitored and/or trained. The plug-in may provide output, such as a probability score of whether it's legitimate, a reuse of a prior statement, and whether it's fake. Additionally, the centralized AI engine, or each individual AI engine associated with applications or plug-ins, may also go a step further to analyze the content of what was spoken or shown in the video to determine if the content is reasonable or likely fake. For example, the AI engine may compare aspects of the content, and/or the content as a whole, against public sources such as for “fact checking.” As such, an AI-based deepfake detection system may compare audio, video, or other multimedia content against an individualized profile model trained on verified voice, facial features, speech patterns of the individual. The AI-based deepfake detection system may also assess, in real time, identified or consumed content to determine whether the identified or consumed content is authentic content and/or to identify artifacts in the multimedia content indicative of a deepfake.

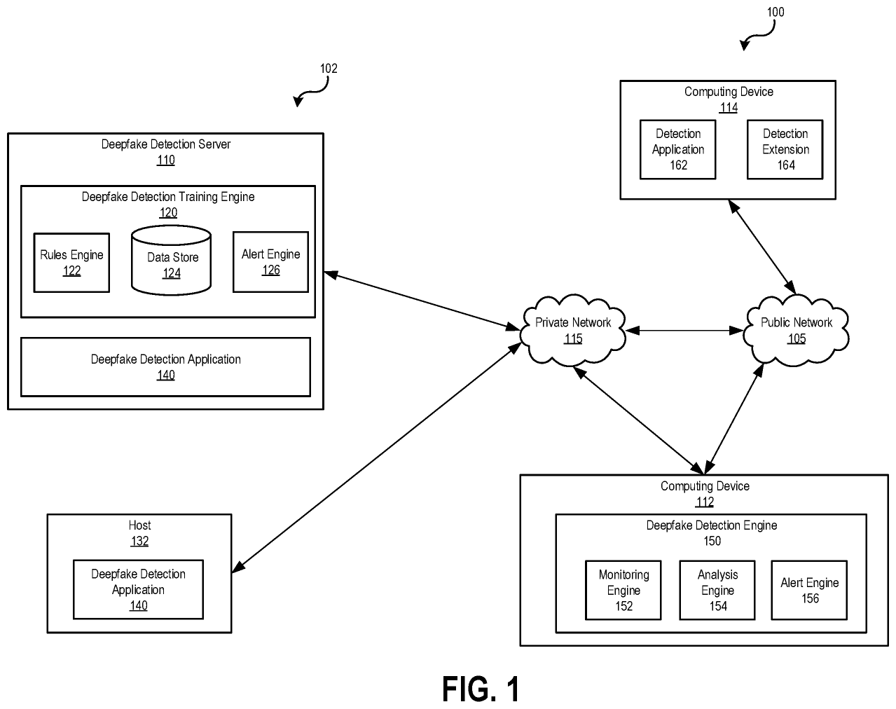

FIG. 1 shows an illustrative computing environment 100 capable of identifying deepfake content in accordance with one or more aspects described herein. The illustrative computing environment 100 may include a plurality of computing devices (e.g., a deepfake detection server 110, a computing device 112, a computing device 114, a host 132, and/or the like) communicatively coupled via a public network 105 and/or a private network 115 to an enterprise computing system. The private network 115 may be connected to one or more computing devices of the enterprise computing infrastructure 102 and/or devices external to the enterprise infrastructure (e.g., the computing device 114). The enterprise computing infrastructure 102 may include one or more computer machines or systems providing products and/or services to a plurality of users. In addition, the computer machines may include one or more computing devices providing security functionality may include deepfake identification and/or monitoring functionality including, for example, multimedia content analysis, event logging, monitoring and investigation of potential deepfake content, generation of alerts reporting suspected deepfake content, preparation of reports regarding deepfake content, takedown requests of identified deepfake content, machine learning, and/or performing remediation. In some cases, deepfake identification and/or monitoring functionality may be performed on a dedicated deepfake detection computing machine and/or the deepfake identification and/or monitoring functionality may be distributed over a plurality of computing devices and/or processes. The computing environment 100 may include a plurality of host computing devices (e.g., host 132, servers, client computing devices, desktop computing devices, workstations and the like), and the like. In some cases, the deepfake identification and/or monitoring functionality to train or otherwise configure identity profiles or personal models to identify and/or generate alerts corresponding to suspicious audio, video, textual or other multimedia content identified as being access on the private network 115 and/or the public network 105, may be performed by a deepfake detection training engine, which may include a rules engine 122, a data store 124 and an alert engine 126. In some cases, the deepfake detection training engine 120 may operate from a central location (e.g., on the deepfake detection server 110). The hosts and/or servers may include one or more data stores personal identity profiles or models.

Each element in computing environment 100 may include one or more computing machines and associated components operating computer software and data configured to perform one or more functions described herein. In addition, and as illustrated in greater detail below, hosts and/or servers may be configured to perform various distributed processing functions described and store, access, and/or act on enterprise data and/or security data. An enterprise computing infrastructure 102 may include one or more computer machines and/or other computer components. In addition, the enterprise computing infrastructure 102 may be configured to provide various enterprise and/or back-office computing functions for an organization. In some cases, the enterprise computing infrastructure 102 may load data from an enterprise data storage platform, manipulate and/or otherwise process such data, and return modified data and/or other data to the enterprise data storage platform and/or to other computer machines or systems in the computing environment 100.

The hosts and servers of the computing environment and the computing devices 112 and 114 may be any type of computer machine and may be linked to and/or used by a specific enterprise user (who may, e.g., be an employee or other affiliate of an enterprise organization controlling and/or interacting with a particular computing device). In some cases, a host (e.g., host 134) may be considered to be an administrative computing device, which may be any type of computer machine and may be linked to and/or used by an administrative user (who may, e.g., be a network administrator of an enterprise organization controlling and/or interacting with computer devices of the enterprise infrastructure 102). In some cases, the computing device 114 may by be any type of computer machines and may be linked to and/or used by one or more external users (who may, e.g., not be associated with an enterprise organization). The computing device 112 may be any type of computer machines and may be linked to and/or used by one or more internal users authorized to access the devices of the enterprise infrastructure. For example, the computing environment 100 may include a private network 115 that may interconnect hosts and servers of the enterprise infrastructure 102, and/or one or more other computer machines or systems, which may be associated with an organization), and a public network 105 that may interconnect the enterprise computer system with the private network 115 and/or one or more other computer machines such as computing device 114, systems, public networks, sub-networks, and/or the like).

In one or more arrangements, computer machines and the other systems in the computing environment 100 may be any computing device capable of providing a user interface, receiving input via the user interface, acting on the input, accessing or processing big data, controlling other computer machines and/or components thereof based on the input, and communicating the received input to one or more other computing machines. As noted above, and as illustrated in greater detail below, any and/or all of the computer machines of the computer environment 100 may, sometimes, be special-purpose computing devices configured to perform specific functions.

The deepfake detection training engine 120 may be configured to train an AI model associated with an identify of an individual as configured by a user. An individual may have an identity profile created with an identity model such that the identity model may be used for identifying characteristic audio, video, textual, and/or other audiovisual characteristics associated with the user, such as vocal patterns, characteristic facial expressions, audio passages, and the like. Profiles and/or models may be stored in the data store 124. The alert engine 126 may be used to generate centralized alerts when a suspected deepfake is identified. In some cases, alerts may be generated locally on a computing device (e.g., such as the computing device 112) or may be centrally generated by the deepfake detection server 110.

In some cases, identify profiles may be used by the system to configure sources of trusted audio, video, textual, and/or other multimedia content that is verified to be associated with a particular individual. The verified content may be provided by the individual themselves, or by an organization associated with the individual. For example, an enterprise organization may provide verified content to be associated with certain key individuals, such as executives, board members, or other key individuals. Such content may be archived footage of speeches, presentations, or other public or private content generated through the enterprise organization. In some cases, such as for celebrities, artists, activists, politicians, or other public figures may have content submitted by organizations of which they are affiliated. In some cases, verified content may be submitted by the individuals themselves. This verified content may be stored locally on the enterprise network (such as in the data store 124) or links to the verified content may be stored in the data store 124.

The verified content may be used to train an AI-model of the rules engine 122, where the model may be continually trained over time, as additional verified content is submitted or identified. The trained model comprises indicators of valid facial expressions, gesture patterns, vocal patterns, eye movement patterns, and the like that can be compared against new audio, video, textual, and/or other multimedia content as it is identified or viewed. For example, the model may be trained on characteristic features of an individual's face (e.g., cheek and forehead appearance, eye and eyebrow movement, glasses glare, hair appearance, and the like). Similarly, the model may be trained on characteristic features of an individual's vocal patterns, such as use of Mel-frequency Cepstral Coefficient (MFCC), which is a feature used for speech recognition.

Model types that may be used for audio, video, textual or other multimedia deepfake identification may include a support vector machine (SVM) model, a multi-layer perceptron (MLP) model, an extreme gradient boosting (XGB) model, a random forest model, a decision tree model, a gaussian naïve Bayes model, an Ada boost model, a quadratic discriminant analysis model, a linear discriminant analysis model, and/or the like. In some cases, the identify profile may include multiple models based on characteristics such as a first model being used for identification of a video characteristic of deepfakes and a second model being used to identify of an audio characteristic of deepfakes. In some cases, text-based models may be used, such as to identify a characteristic of deepfake generated text, such as on captions and/or subtitles applied to video feeds or otherwise associated with an audio feed.

Because individuals consume multimedia content via a number of channels, such as on a social media website, through social media applications, via email, texting, or instant messaging applications, and the like, the deepfake detection system may include multiple detection applications and/or plug-ins that may be installed at a central location of the enterprise network (e.g., the deepfake detection application 140 installed on the host device 132 and/or the deepfake detection server. In some cases, user devices may have one or more deepfake detection applications and/or extensions that may be stand-alone applications or extensions to applications installed on a user device, such as a smart phone, laptop, tablet computing device, or the like. For example, a user device (e.g., the computing device 114) may include a detection application 162 that may be used to access and analyze veracity of multimedia content and/or a detection extension 164 that may be integrated with another application, such as a browser application, a social media application and the like.

The illustrative computing device 112 is shown with a deepfake detection engine 150 that may be integrated in a stand-alone application, as an extension, or the like. The deepfake detection engine 150 may include a monitoring engine 152, an analysis engine 154, and an alert engine 156. The deepfake detection engine 150 may be configured to monitor multimedia content associated with selected individuals, such as by a configuration file specifying particular user profiles. The configured user profiles may be uploaded from the deepfake detection server 110, and may include one or more trained deepfake identification model for each configured profile. The monitoring engine 152 may be configured to monitor, in real time, multimedia content consumed by a user of the computing device 112. For example, when a user accesses a multimedia file online, such as a video posted on social media, the monitoring engine 152 may identify the multimedia file to allow the analysis engine 154 to analyze the file concurrently while the user watches the video.

In some cases, the analysis engine 154 may process the multimedia file before the user watches the video. The analysis engine 154 may include an AI-based model processing engine which may process one or more aspects of the multimedia file such as a video signal, an audio signal, a combined audio and video signal, a text feed, and/or the like. For example, the analysis engine may process a combined audio-visual signal of the multimedia file and may compare a synchronization between a visual representation of the individual's facial expressions and lip movements with the audio signal. In some cases, the analysis engine 154 may analyze an audio signal to identify one or more audio artifacts based on the trained AI model. In some cases, the analysis engine 154 may process text (e.g., subtitles, captions, and the like) associated with the multi-media file based on the AI model to discriminate between the text generated by the individual and/or text that matches an audio and/or video portion of the multimedia file, and machine generated text. In some cases, the analysis engine may generate a probability score that is associated with a likelihood that one or more portions of a multimedia file is a deepfake.

For example, the AI model or models may output a value that indicates a closeness to validated audio, video and/or text known to be created by the individual. That score may be compared to a threshold (e.g., about 80, about 90, and the like) where a score greater than or equal to the threshold indicates a likelihood that the accessed multimedia file is valid. When multiple models are used (e.g., a video-based model, an audio-based model, a text-based model), the scores may be combined based on a formula, such as P=a*Vₛ+b*Aₛ+c*Tₛ, where Vₛ corresponds to a likelihood that the video is either a deepfake or valid, Aₛ corresponds to a likelihood that the audio is either a deepfake or valid, and Tₛ corresponds to a likelihood that the text is either a deepfake or valid, and a, b, and c, are weighting values.

If the likelihood score meets or exceeds a first threshold that the multimedia file is a valid product associated with the individual, then the user is allowed to consume the content. In some cases, meeting a validity threshold may cause the deepfake detection engine 150 to communicate a link to the content to the deepfake detection training engine 120 for use in continuous training of the model. In some cases, such as if the individual is associated with the enterprise organization, before using new content to train the model, the content may be presented to an individual within the organization, such as via the host 132, to solicit feedback and upon receiving an approval input will initiate a training sequence by the deepfake detection training engine. In some cases, the deepfake detection training engine may initiate training of the model or models when a threshold number of devices (e.g., 20 device, 30 devices, and the like) provide an indication that the content is likely valid or a deepfake. If a discrepancy occurs between validity scores from different computing devices, an alert may be generated by the alert engine 126 to initiate further review of the content.

If, the likelihood score meets a second threshold condition (e.g., below 60, below 50, and the like), the deepfake detection engine 150 may indicate that the content is likely a deepfake and may cause the alert engine 156 to generate an alert to the user of the computing device 112. For example, the deepfake detection engine 150 may generate an audio and/or video alert to indicate to the user that the accessed content is likely a deepfake. In some cases, the deepfake detection engine 150 may block viewing of the content and/or may output a notice that the content is likely a deepfake. In some cases, the deepfake detection engine 150 may communicate the link to the deepfake detection training engine 120 for additional analysis and/or to trigger a further response (such as when multiple (e.g., 20, 50, and the like) computing devices have indicated that the content is likely a deep fake. For example, the alert engine 126 may cause an alert notification to be sent to the individual that is subject to the deepfake, an alert notification (e.g., a takedown request) to a website hosting the content, and/or an alert notification to law enforcement organization having jurisdiction to the individual's geographic location and/or the website's geographic location. If the likelihood score falls between the deepfake indication threshold and the validity indication threshold, the deepfake detection engine 150 may communicate the information to the deepfake detection training engine to initiate further analysis. In such cases, the alert engine 156 may generate a warning indication for display at the computing device 112 that indicates one or more validity issues have been identified with respect to the accessed content. In some cases, the warning indication may be viewed concurrently with the content viewing on a display of the computing device 112. In some cases, the warning indication may be presented, with a request for user acknowledgement, at a user interface of the computing device 112 before allowing access to the content.

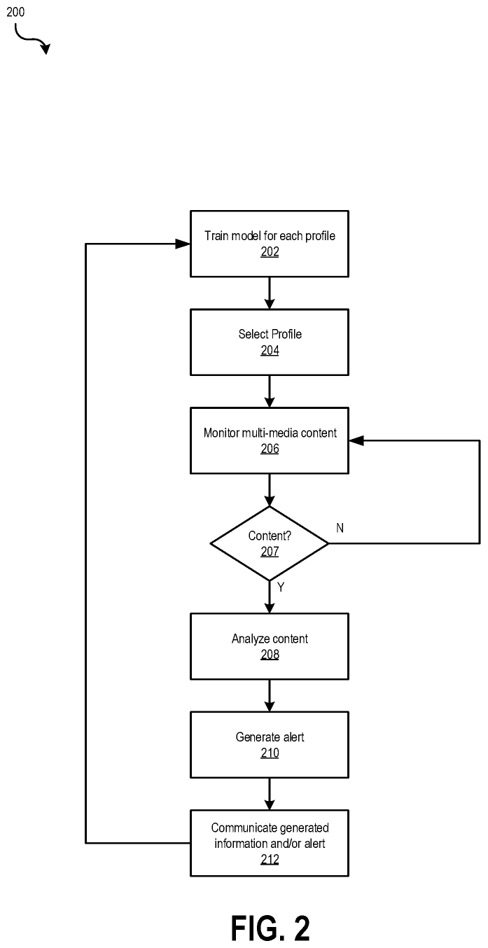

FIG. 2 shows an illustrative method for identify deepfake content in accordance with one or more aspects described herein. At 202, the deepfake detection training engine may train one or more deepfake detection models (e.g., an audio model, a video model, an audio/video model, a text model, and the like) for an individual profile. In some cases, the profiles may be input at the deepfake detection server 110, such as for famous or influential people including politicians, actors, musical artists, authors, pundits, and the like. In some cases, profiles may be created based on a user profile generated at a computing device, such as when a local user desires to monitor content associated with that individual. For example, a business owner or responsible party, may initiate deepfake monitoring functionality for one or more individuals associated with the business organization. In another example, an individual may request deepfake monitoring of content associated with themselves, a family member, a friend and/or the like. Once created, profiles are communicated to the deepfake detection training engine 120 and stored in the data store 124. Trained models are also stored in the data store 124. The rules engine 122 processes AI rules to train the model continuously based on known-good content, validated content, and/or known deepfake content.

At 204, a user of a computing device (e.g., computing device 112, computing device 1114, host device 132) may configure the deepfake detection by the deepfake detection engine 150 (e.g., the detection application 140, the detection application 162 the detection extension 164, and the like). In some cases, the deepfake detection engine functionality may be provided to third-parties via an application programming interface where the deepfake detection functionality may be performed by the deepfake detection application installed on the host device 132, to allow the deepfake detection functionality to be integrated into third-party applications (e.g., a social media application). The user of the computing device may specify sources to be monitored (e.g., social media websites, company websites, email, chat, and instant messaging applications, and/or the like). The configuration may also request continual monitoring in the background, on-access monitoring, user-initiated analysis, and the like. Once configured, selected monitoring of content is initiated at 206 by the monitoring engine 152.

At 207, if content associated with one or more configured individuals is recognized, analysis of the content is performed at 208, otherwise analysis continues at 206. At 208, when configured individual content is identified, the deepfake detection engine 150 initiates AI-based analysis of the content by the analysis engine 154. For example, content may be analyzed with respect to one or more trained AI models. The AI models may be stored locally to the computing device 112, or may be accessed on-demand from the data store 124 of the deepfake detection training engine 120 to ensure use of the most recent trained model. If, at 210, content is found that fails to meet a validity threshold an alert may be generated and communicated based on one or more configured settings at 212.

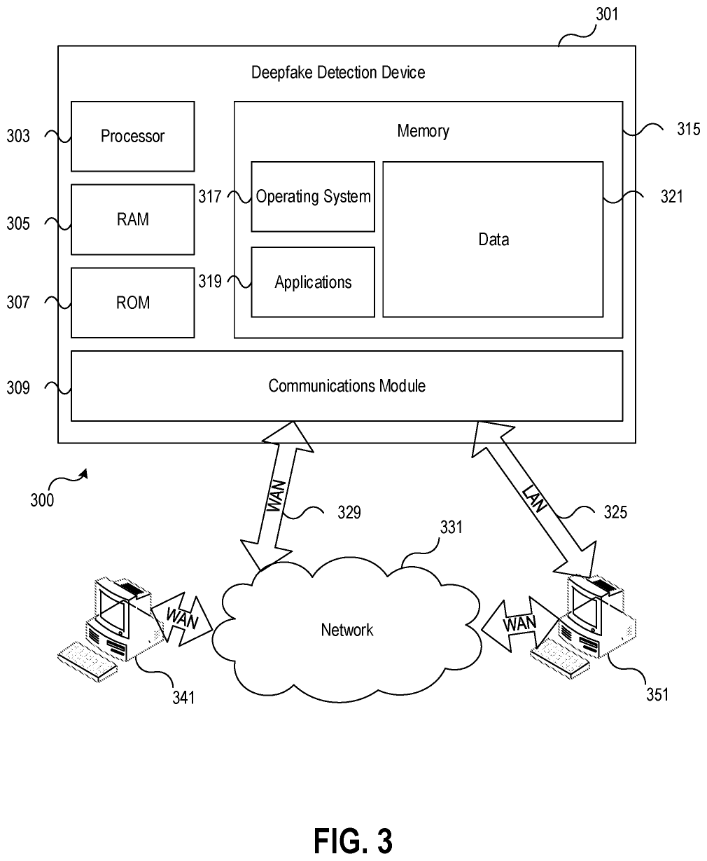

FIG. 3 shows an illustrative operating environment in which various aspects of the present disclosure may be implemented in accordance with one or more illustrative embodiments. Referring to FIG. 3 a computing system environment 300 may be used according to one or more illustrative embodiments. The computing system environment 300 is only one example of a suitable computing environment and is not intended to suggest any limitation as to the scope of use or functionality contained in the disclosure. The computing system environment 300 should not be interpreted as having any dependency or requirement relating to any one or combination of components shown in the illustrative computing system environment 300.

The computing system environment 300 may include an illustrative deepfake detection device 301 having a processor 303 for controlling overall operation of the deepfake detection device 301 and its associated components, including a Random Access Memory (RAM) 305, a Read-Only Memory (ROM) 307, a communications module 309, and a memory 315. The deepfake detection device 301 may include a variety of computer readable media. Computer readable media may be any available media that may be accessed by the deepfake detection device 301, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by the deepfake detection device 301.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed by the processor 303 of the deepfake detection device 301. Such a processor may execute computer-executable instructions stored on a computer-readable medium.

Software may be stored within the memory 315 and/or other digital storage to provide instructions to the processor 303 for enabling the deepfake detection device 301 to perform various functions as discussed herein. For example, the memory 315 may store software used by the deepfake detection device 301, such as an operating system 317, one or more application programs 319, and/or an associated database 321. In addition, some or all of the computer executable instructions for the deepfake detection device 301 may be embodied in hardware or firmware. Although not shown, the RAM 305 may include one or more applications representing the application data stored in the RAM 305 while the deepfake detection device 301 is on and corresponding software applications (e.g., software tasks) are running on the deepfake detection device 301.

The communications module 309 may include a microphone, a keypad, a touch screen, and/or a stylus through which a user of the deepfake detection device 301 may provide input, and may include one or more of a speaker for providing audio output and a video display device for providing textual, audiovisual and/or graphical output. The computing system environment 300 may also include optical scanners (not shown).

The deepfake detection device 301 may operate in a networked environment supporting connections to one or more remote computing devices, such as the computing devices 341 and 351. The computing devices 341 and 351 may be personal computing devices or servers that include any or all of the elements described above relative to the deepfake detection device 301.

The network connections depicted in FIG. 3 may include a Local Area Network (LAN) 325 and/or a Wide Area Network (WAN) 329, as well as other networks. When used in a LAN networking environment, the deepfake detection device 301 may be connected to the LAN 325 through a network interface or adapter in the communications module 309. When used in a WAN networking environment, the deepfake detection device 301 may include a modem in the communications module 309 or other means for establishing communications over the WAN 329, such as a network 331 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

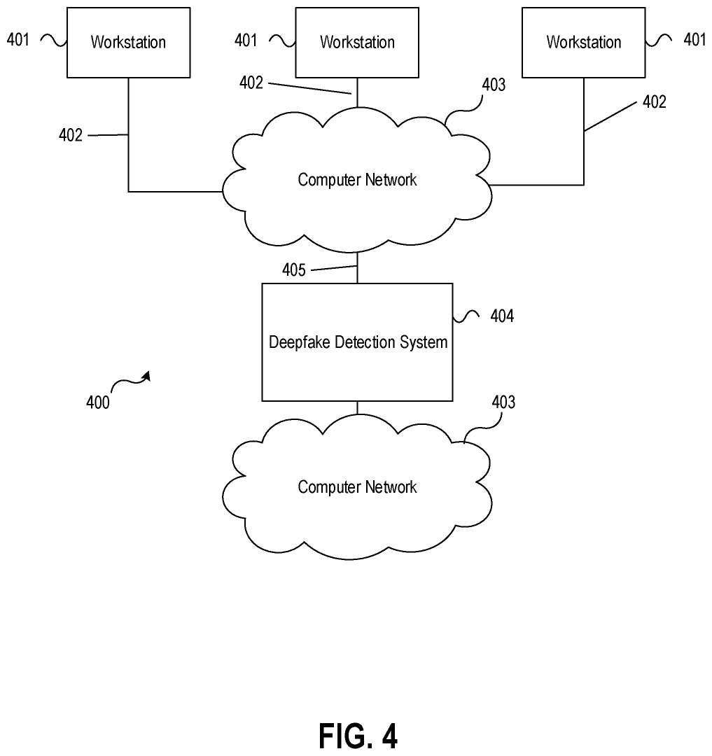

FIG. 4 shows an illustrative block diagram of workstations and servers that may be used to implement the processes and functions of certain aspects of the present disclosure in accordance with one or more example embodiments. For example, an illustrative system 400 may be used for implementing illustrative embodiments according to the present disclosure. As illustrated, the system 400 may include one or more workstation computers 401. The workstation 401 may be, for example, a desktop computer, a smartphone, a wireless device, a tablet computer, a laptop computer, and the like, configured to perform various processes described herein. The workstations 401 may be local or remote, and may be connected by one of the communications links 402 to a computer network 403 that is linked via the communications link 405 to a deepfake detection system 404. In the system 400, the deepfake detection system 404 may be a server, processor, computer, or data processing device, or combination of the same, configured to perform the functions and/or processes described herein. The deepfake detection system 404 may be used to receive check images and associated data and/or validation scores, retrieve user profile, evaluate the check image compared to the user profile, identify matching or non-matching elements, generate user interfaces, and the like.

The computer network 403 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. The communications links 402 and 405 may be communications links suitable for communicating between the workstations 401 and the deepfake detection system 404, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a deepfake detection training device comprising a data store storing a plurality of trained models, wherein a first trained model is associated with a first profile;
a computing device comprising:
a processor; and
memory storing computer-readable instructions that, when executed by the processor, cause the computing device to:
receive, based on identification of the first profile and from the deepfake detection training device, the first trained model;
monitor, based on the first profile, a plurality of content files accesses by the computing device;
identify, based on the first profile, first multimedia content associated with the first profile;
analyze, based on the first trained model, the first multimedia content; and
initiate, based on a deepfake indicator, a deepfake identification response.

2. The system of claim 1, wherein the deepfake indication response comprises blocking the first multimedia content from being presented to a user of the computing device.

3. The system of claim 2, wherein the deepfake indication response comprises temporarily blocking the first multimedia content from being presented to a user of the computing device until entry of an acknowledgement input.

4. The system of claim 1, wherein the instructions further cause the computing device to solicit configuration information from a user, wherein the configuration information corresponds to a deepfake response action associated with the first profile.

5. The system of claim 1, wherein the deepfake detection training device further comprises second memory storing second computer readable instructions that, when executed by a second processor, cause the deepfake detection training device to train a first model on validated content associated with the first profile.

6. The system of claim 5, wherein the training of the first model occurs continuously.

7. The system of claim 1, wherein the first trained model comprises one or more of a video analysis model and an audio analysis model.

8. A method comprising:
receiving, based on identification of a first profile and from a deepfake detection training device, one or more trained first models;
monitoring, based on the first profile, a plurality of content files accesses by a computing device;
identifying, based on the first profile, first multimedia content associated with the first profile;
analyzing, based on the one or more trained first models, the first multimedia content; and
initiating, based on a deepfake indicator, a deepfake identification response.

9. The method of claim 8, wherein the deepfake indication response comprises blocking the first multimedia content from being presented to a user of the computing device.

10. The method of claim 9, wherein the deepfake indication response comprises blocking, temporarily, the first multimedia content from being presented to a user of the computing device until entry of an acknowledgement input.

11. The method of claim 8, further comprising soliciting configuration information from a user, wherein the configuration information corresponds to a deepfake response action associated with the first profile.

12. The method of claim 8, further comprising training the one or more first models on validated content associated with the first profile.

13. The method of claim 12, wherein the training of the one or more first models occurs continuously.

14. The method of claim 8, wherein the trained one or more first models comprises one or more of a video analysis model, an audio analysis model, and a text analysis model.

15. A computing device comprising:
a processor; and
memory storing instructions that, when executed by the processor, cause the computing device to:
receive, based on identification of a first profile and from a deepfake detection training device, the first trained model;
monitor, based on the first profile, a plurality of content files accesses by the computing device;
identify, based on the first profile, first multimedia content associated with the first profile;
analyze, based on the first trained model, the first multimedia content; and
initiate, based on a deepfake indicator, a deepfake identification response.

16. The computing device of claim 15, wherein the deepfake indication response comprises blocking the first multimedia content from being presented to a user of the computing device.

17. The computing device of claim 15, wherein the deepfake indication response comprises temporarily blocking the first multimedia content from being presented to a user of the computing device until entry of an acknowledgement input.

18. The computing device of claim 15, wherein the instructions further cause the computing device to solicit configuration information from a user, wherein the configuration information corresponds to a deepfake response action associated with the first profile.

19. The computing device of claim 15, wherein the instructions further cause the computing device to communicate training content associated with the first profile to the deepfake detection training device.

20. The computing device of claim 15, wherein a first trained model comprises one or more of a video analysis model, an audio analysis model, and a text analysis module.
